(19) United States
(12) Patent Application Publication
(10) Pub. No.: US 2010/0292875 A1
(43) Pub. Date: Nov. 18, 2010

(54) Method for Braking a Rail Vehicle

(75) Inventor: Hagen GROSS, Erlangen (DE)

Correspondence Address: HARNESS, DICKEY & PIERCE, P.L.C., P.O.BOX 8910, RESTON, VA, 20195, US

(73) Assignee: SIEMENS AKTIENGESELLSCHAFT, Muenchen (DE)

(21) Appl. No.: 12/224,292

(22) PCT Filed: Jan. 16, 2007
(86) PCT No.: PCT/EP2007/050398

§ 371 Date: Aug. 22, 2008

(30) Foreign Application Priority Data
Feb. 23, 2006 (DE) 10 2006 008 479.9
Mar. 15, 2006 (DE) 10 2006 011 963.0

(51) Int. Cl. B61H 13/00; G06F 19/00; B60T 8/18; B60T 8/172; B60T 8/17; B61H 11/00; B61H 13/30

(52) U.S. Cl. 701/19

(57) ABSTRACT

The invention relates to a method for braking a rail vehicle which has at least two individually actuable brake systems, in particular at least one electric brake system and at least one mechanical brake system, wherein the brake systems are actuated depending on their availability. There is provision for the mass of the rail vehicle which is to be braked and for each brake system to determine the instantaneously available brake forces (actual forces). The instantaneously required braking force (setpoint force) is also determined. The setpoint force is then distributed between the brake systems—taking into account the mass to be braked and the actual forces by means of a management function—in that the management function actuates the brake systems individually or in a combined fashion.

This application is the national phase under 35 U.S.C.§371 of PCT International Application No. PCT/EP2007/050398 which has an International filing date of Jan. 16, 2007,which designated the United States of America and which claims priority on German application Nos. 10 2006 008 479.9 filed Feb. 23, 2006 and 10 2006 011 963.0 filed Mar. 15, 2006, the entire contents of each of which are hereby incorporated herein by reference.

### FIELD

At least one embodiment of the invention generally relates to a method for braking a rail vehicle which has at least two brake systems which can be actuated individually, in particular at least one electric brake system and/or at least one mechanical brake system, wherein the brake systems are actuated as a function of their availability.

### BACKGROUND

Previously it was customary for the required braking force to be distributed among two existing brake systems under the control of a brake control device. In this context the important factor was in particular that if one of the brake systems had failed, another brake system was not additionally loaded to a corresponding degree.

Hitherto, attention was only ever paid to the instantaneous availability of the individual brake systems, and in this context an electric brake was generally preferred for braking.

GB 2 154 294 A discloses a method for braking a rail vehicle in which the required braking force is distributed among a plurality of brakes taking into account the mass of the rail vehicle.

### SUMMARY

At least one embodiment of the invention specifies a method for braking a rail vehicle which continuously permits optimum distribution of the necessary braking force among the brake systems which are present.

In at least one embodiment of the invention, the mass of the rail vehicle which is to be braked and the instantaneously available braking forces (actual forces) are determined for each brake system, in that the instantaneously required braking force (setpoint force) is determined, and in that the required braking force is distributed among the brake systems taking into account the mass to be braked and the available braking forces by way of a management function in that the management function actuates the brake systems individually or in combination.

The computer for the management function differs from the known brake control device. In the known device, the necessary braking force is distributed only on the basis of the availability of the brake systems. With the method according to at least one embodiment of the invention, not only is it checked whether the brake systems are functionally capable, and a backup brake system activated if this is not the case, but also the instantaneously available braking force (actual force) is determined for each brake system.

If, in addition to the mass which is to be braked (unladen mass+payload), that is to say the actual mass of the rail vehicle which can usually be obtained by weighing, the various actual forces of the brake systems are also known, the instantaneously required braking force (setpoint force) is determined. The setpoint force depends, on the one hand, on the magnitude of the deceleration (negative acceleration) which the driver of the vehicle predefines and, on the other hand, on the section of road being traveled on, specifically whether, for example, a positive or a negative gradient is present. In order then to actually generate the determined required braking force, the management computer actuates these brake systems individually even in the normal operating mode when all the brake systems are functionally capable. In doing so, the management computer distributes the required braking force, which is also referred to as setpoint force, among the brake systems which are present, taking into account the respective actual forces and the mass which is to be braked.

The method according to at least one embodiment of the invention provides the advantage that uniform and therefore optimum loading on the individual brake systems is made possible.

For example, when the actual forces of the brake systems are determined, the maximum thermal and/or mechanical loading on the brake systems is taken into account. Overheating or mechanical damage is therefore prevented.

### DETAILED DESCRIPTION OF THE EXAMPLE EMBODIMENTS

According to a first example, the management function minimizes the component wear when the necessary braking force is being distributed among the brake systems. The management function always actuates the brake systems in such a way that those brake systems which have a higher degree of wear are as far as possible spared. Electric brakes are therefore preferred to mechanical brakes.

For example, the component wear is distributed here uniformly among the wagons of the rail vehicle which are present. For example in the case of a train, which is composed of a plurality of wagons, the mechanical brakes of the individual wagons are therefore subjected to the same degree of loading.

According to a second example, the management function distributes the required braking force among the brake systems in such a way that a maximum value of the friction of the wheels on the rail which was defined previously in order to protect against slipping. This prevents the train being braked to such a high degree that locked wheels on the rail slip, which is unfavorable for the braking operation.

For example, the component wear is minimized in compliance with the maximum value of the friction. The management function therefore combines the two preconditions for optimum braking, specifically that the wheels do not slide on the rail, and nevertheless the component wear by the brakes remains as small as possible.

For example, smooth switching is carried out between the specification that the component wear is to be minimized and the specification that the required friction of the wheels on the rail is minimized. The smooth switching provides the advantage that a jolt which is unpleasant for the passengers does not occur when the vehicle is braked.

For example, the use of the at least one mechanical brake system is minimized. Since an electric brake system experiences less wear, the entire wear of the brake systems is reduced by the preference for the electric brake system.

According to another example, the at least one electric brake system is used first, and the at least one mechanical brake system is used only afterwards. Basically, at first an attempt is made to make available the setpoint force solely through the at least one electric, brake system. The at least one mechanical brake system is then activated only if the actual forces of the at least one electric brake system are not sufficient.

For example, when the required braking force is being distributed among the brake systems in the region of a station, the management function does not fully use the at least one electric brake system in order to permit control of the at least one electric brake system. An additionally necessary braking force comes from the at least one mechanical brake system. An additionally required braking force then comes from the at least one mechanical brake system. The travel to a stopping point can then be controlled better until the rail vehicle comes to a standstill. As a result of the control of an electric brake system which is made possible and which can be controlled dynamically, a desired stopping point can be reached quickly with a high degree of accuracy.

According to one development of the method, if a brake system fails, braking is carried out with the other, still available brake systems.

With the method for braking a rail vehicle according to at least one embodiment of the invention, the use of the management function provides in particular the advantage that the brake systems which are present are always used in an optimum way during a braking operation.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for braking a rail vehicle including at least two individually actuatable brake systems wherein the brake systems are actuatable as a function of their availability, that the method comprising:
determining a mass of the rail vehicle to be braked and available braking forces for each of the at least two brake systems;
determining a required braking force; and
distributing the required braking force among the at least two brake systems, taking into account the determined mass to be braked and the determined available braking forces via a management function, the management function being useable to actuate the at least two brake systems at least one of individually and in combination.

2. The method as claimed in claim 1, wherein, when the available braking forces of the at least two brake systems are determined, at least one of the maximum thermal and mechanical loading on the brake systems is taken into account.

3. The method as claimed in claim 1, wherein the management function minimizes component wear when the necessary braking force is distributed among the at least two brake systems.

4. The method as claimed in claim 3, wherein the component wear is distributed uniformly among wagons of the rail vehicle which are present.

5. The method as claimed in claim 1, wherein when the required braking force is distributed among the at least two brake systems, the management function does not exceed a maximum value of the friction of wheels on the rail which was defined previously in order to protect against slipping.

6. The method as claimed in claim 5, wherein the component wear is minimized in compliance with the maximum value of the friction.

7. The method as claimed in claim 6, wherein smooth switching is carried out between minimizing the component wear and minimizing the required friction of the wheels on the rail.

8. The method as claimed in claim 1, wherein the use of the at least one mechanical brake system is minimized.

9. The method as claimed in claim 1, wherein the at least one electric brake system is used first, and the at least one mechanical brake system is used only afterward the at least one electric brake system is used.

10. The method as claimed in claim 1, wherein, when the required braking force is being distributed among at least two the brake systems in the region of a station, the management function does not fully use the at least one electric brake system in order to permit control, and wherein an additionally necessary braking force comes from the at least one mechanical brake system.

11. The method as claimed in claim 1, wherein the at least two individually actuatable brake systems include at least one of at least one electric brake system and at least one mechanical brake system.

12. The method as claimed in claim 2, wherein the management function minimizes component wear when the necessary braking force is distributed among the at least two brake systems.

13. The method as claimed in claim 12, wherein the component wear is distributed uniformly among wagons of the rail vehicle which are present.

14. The method as claimed in claim 2, wherein when the required braking force is distributed among the at least two brake systems, the management function does not exceed a maximum value of the friction of wheels on the rail which was defined previously in order to protect against slipping.

15. The method as claimed in claim 14, wherein the component wear is minimized in compliance with the maximum value of the friction.

16. The method as claimed in claim 2, wherein the at least one electric brake system is used first, and the at least one mechanical brake system is used only afterward the at least one electric brake system is used.

17. The method as claimed in claim 2, wherein, when the required braking force is being distributed among at least two the brake systems in the region of a station, the management function does not fully use the at least one electric brake system in order to permit control, and wherein an additionally necessary braking force comes from the at least one mechanical brake system.

18. The method as claimed in claim 1, wherein the available brakes forces determined are instantaneously available braking forces and wherein the required braking force is an instantaneously required braking force.
